(19) United States
(12) Patent Application Publication
(10) Pub. No.: US 2026/0042876 A1
(43) Pub. Date: Feb. 12, 2026

(54) LOW Tg MULTI-TETHER COPOLYMERIZED DIBLOCK COPOLYMERS FOR DIRECTED SELF-ASSEMBLY

(71) Applicant: Merck Patent GMBH, Darmstadt (DE)

(72) Inventors: Durairaj Baskaran, Bridgewater, NJ (US); Md S. Rahman, Flemington, NJ (US); Victor Monreal, Breinigsville, PA (US)

(21) Appl. No.: 19/099,714

(22) PCT Filed: Aug. 14, 2023
(86) PCT No.: PCT/EP2023/072371

§ 371 Date: Jan. 29, 2025

Related U.S. Application Data
(60) Provisional application No. 63/371,585, filed on Aug. 16, 2022.

(51) Int. Cl. C08F 293/00; C08F 212/08; C08F 297/02

(52) U.S. Cl. CPC C08F 293/005; C08F 212/08; C08F 297/026

(57) ABSTRACT

Disclosed are two different block copolymer families having general structures (I) or (III), composition thereof, and the process of using these compositions for DSA; wherein B segment and B₁ segment are polar block copolymer segments comprising either alkyl 2-methylenealkanoate derived repeating units, lactone derived repeat units, oxirane derived repeat units, oxetane or cyclic carbonate derived repeat units; L and L₁ are either a direct valence bond or a linking moiety derived from a 1,1-diarylethene; A segment and A₁ are non-polar block copolymer segment comprising styrenic repeat unit, E′, E″ E³ and E⁴ are different types of end groups, A₂ is a block segment derived from an olefin or a diene having a T_{g} of about −5° C. to about −50° C., and in structure (I) is multi-tethered with oligo flexible tethered groups at various positions as outlined. E′-A-L-B-E″ (I) E³-A₁-A₂-L₁-B₁-E⁴ (III)

### FIELD OF THE INVENTION

The invention relates to block copolymer families of general structures (I) and (III) and to methods for using composition of these block copolymers for aligning microdomains of self-assembling block copolymers (BCP) to form self-assembled geometries which are useful for forming arrays of contact holes or lines and spaces. These compositions and processes are useful for fabrication of electronic devices.

### BACKGROUND

Self-assembly of block copolymers is a method useful for generating smaller and smaller patterned features for the manufacture of microelectronic devices in which the critical dimensions (CD) of features on the order of nanoscale can be achieved. Self-assembly methods are desirable for extending the resolution capabilities of microlithographic technology for repeating features such as an array of contact holes or posts. In a conventional lithography approach, ultraviolet (UV) radiation may be used to expose through a mask onto a photoresist layer coated on a substrate or layered substrate. Positive or negative photoresists are useful, and these can also contain a refractory element such as silicon to enable dry development with conventional integrated circuit (IC) plasma processing. In a positive photoresist, UV radiation transmitted through a mask causes a photochemical reaction in the photoresist such that the exposed regions are removed with a developer solution or by conventional IC plasma processing. Conversely, in negative photoresists, UV radiation transmitted through a mask causes the regions exposed to radiation to become less removable with a developer solution or by conventional IC plasma processing. An integrated circuit feature, such as a gate, via or interconnect, is then etched into the substrate or layered substrate, and the remaining photoresist is removed. When using conventional lithographic exposure processes, the dimensions of features of the integrated circuit feature are limited. Further reduction in pattern dimensions is difficult to achieve with radiation exposure due to limitations related to aberrations, focus, proximity effects, minimum achievable exposure wavelengths and maximum achievable numerical apertures. The need for large-scale integration has led to a continued shrinking of the circuit dimensions and features in the devices. In the past, the final resolution of the features has been dependent upon the wavelength of light used to expose the photoresist, which has its own limitations. Directed (a.k.a. guided) self-assembly techniques, such as graphoepitaxy and chemoepitaxy using block copolymer imaging, which employ a patterned area on a substrate, are highly desirable techniques used to enhance resolution while reducing CD variation. These techniques can be employed to either enhance conventional UV lithographic techniques or to enable even higher resolution and CD control in approaches employing EUV, e-beam, deep UV or immersion lithography. The directed self-assembly block copolymer comprises a block of etch resistant copolymeric unit and a block of highly etchable copolymeric unit, which when coated, aligned and etched on a substrate give regions of very high-density patterns.

For directed (guided), or unguided self-assembly, of a block copolymer film, respectively, on a patterned or non-patterned substrate area, typically the self-assembly process of this block polymer layer occurs during annealing of this film overlying a neutral layer. This neutral layer over a semiconductor substrate may be an unpatterned neutral layer, or in chemoepitaxy or graphoepitaxy, this neutral layer may contain, respectively, graphoepitaxy or chemoepitaxy guiding features (formed through the above-described UV lithographic technique). During annealing of the block copolymer film, the underlying, neutral layer, directs the nano-phase separation of the block copolymer domains. One example is the formation phase separated domains which are lamellas or cylinders perpendicular to the underlying neutral layer surface. These nano-phase separated block copolymer domains, form a pre-pattern (e.g., line and space L/S) which may be transferred into the substrate through an etching process (e.g., plasma etching). In graphoepitaxy, or in chemoepitaxy, these guiding features may dictate both pattern rectification and pattern multiplication. In the case of an unpatterned neutral layer this produces a repeating array of for instance L/S or CH. For example, in a conventional block copolymer such as poly(styrene-b-methyl methacrylate (P(S-b-MMA)), in which both blocks have similar surface energies at the BCP-air interface, this can be achieved by coating and thermally annealing the block copolymer on a layer of non-preferential or neutral material that is grafted or cross-linked at the polymer-substrate interface.

In the graphoepitaxy directed self-assembly method, the block copolymers self organizes around a substrate that is pre-patterned with conventional lithography (Ultraviolet, Deep UV, e-beam, Extreme UV (EUV) exposure source) to form repeating topographical features such as a line/space (L/S) or contact hole (CH) pattern. In an example of a L/S directed self-assembly array, the block copolymer can form self-aligned lamellar regions which can form parallel line-space patterns of different pitches in the trenches between pre-patterned lines, thus enhancing pattern resolution by subdividing the space in the trench between the topographical lines into finer patterns. For example, a diblock copolymer or a triblock copolymer which is capable of microphase separation and comprises a block rich in carbon (such as styrene or containing some other element like Si, Ge, Ti) which is resistant to plasma etch, and a block which is highly plasma etchable or removable, can provide a high-resolution pattern definition. Examples of highly etchable blocks can comprise monomers which are rich in oxygen, and which do not contain refractory elements and are capable of forming blocks which are highly etchable, such as methyl methacrylate. The plasma etching gases used in the etching process of defining the self-assembly pattern typically are those used in processes employed to make integrated circuits (IC). In this manner, very fine patterns can be created in typical IC substrates than were definable by conventional lithographic techniques, thus achieving pattern multiplication. Similarly, features such as contact holes can be made denser by using graphoepitaxy in which a suitable block copolymer arranges itself by directed self-assembly around an array of contact holes or posts defined by conventional lithography, thus forming a denser array of regions of etchable and etch resistant domains which when etched give rise to a denser array of contact holes. Consequently, graphoepitaxy has the potential to offer both pattern rectification and pattern multiplication.

In chemical epitaxy, or pinning chemical epitaxy, the self-assembly of the block copolymer is formed on a surface whose guiding features are regions of differing chemical affinity, having no, or insignificant topography (a.k.a. non-guiding topography) which predicates the directed self-assembly process. For example, the surface of a substrate could be patterned with conventional lithography (UV, Deep UV, e-beam EUV) to create surfaces of different chemical affinity in a line and space (L/S) pattern in which exposed areas whose surface chemistry had been modified by irradiation alternate with areas which are unexposed and show no chemical change. These areas present no topographical difference but do present a surface chemical difference or pinning to direct self-assembly of block copolymer segments. Specifically, the directed self-assembly of a block copolymer whose block segments contain etch resistant (such as styrene repeat unit) and rapidly etching repeat units (such as methyl methacrylate repeat units) would allow precise placement of etch resistant block segments and highly etchable block segments over the pattern. This technique allows for the precise placement of these block copolymers and the subsequent pattern transfer of the pattern into a substrate after plasma or wet etch processing. Chemical epitaxy has the advantage that it can be fine-tuned by changes in the chemical differences to help improve line-edge roughness and CD control, thus allowing for pattern rectification. Other types of patterns such as repeating contact holes (CH) arrays could also be pattern rectified using chemoepitaxy.

These neutral layers are layers on a substrate or the surface of a treated substrate which have no affinity for either of the block segment of a block copolymer employed in directed self-assembly. In the graphoepitaxy method of directed self-assembly of block copolymer, neutral layers are useful as they allow the proper placement or orientation of block polymer segments for directed self-assembly which leads to proper placement of etch resistant block polymer segments and highly etchable block polymer segments relative to the substrate. For instance, in surfaces containing line and space features which have been defined by conventional radiation lithography, a neutral layer allows block segments to be oriented so that the block segments are oriented perpendicular to the surface of the substrates, an orientation which is ideal for both pattern rectification and pattern multiplication depending on the length of the block segments in the block copolymer as related to the length between the lines defined by conventional lithography. If a substrate interacts too strongly with one of the block segments it would cause it to lie flat on that surface to maximize the surface of contact between the segment and the substrate; such a surface would perturb the desirable perpendicular alignment which can be used to either achieve pattern rectification or pattern multiplication based on features created through conventional lithography. Modification of selected small areas or pinning of substrate to make them strongly interactive with one block of the block copolymer and leaving the remainder of the surface coated with the neutral layer can be useful for forcing the alignment of the domains of the block copolymer in a desired direction, and this is the basis for the pinned chemoepitaxy or graphoepitaxy employed for pattern multiplication.

Directing self-assembly (DSA) of diblock copolymers such as polystyrene-b-polymethylmethacrylate (PS-b-PMMA) block copolymer is widely used as next generation lithography patterning. Microphase separation of diblock copolymer is used for feature size control in lithography. These diblock copolymer can produce mono and unidirectional feature sizes in thin film morphology with appropriate underlayer or prepattern for DSA application. However, one problem is that Defect free assembly process of block copolymers requires high thermal energy and longer time. To resolve this problem there is a need for new diblock copolymers which have better block segment mobility and less stringent annealing requirements which will reduce the number of defects defect achieved through DSA processing IC patterns with smaller sizes.

### DETAILED DESCRIPTION OF DRAWINGS

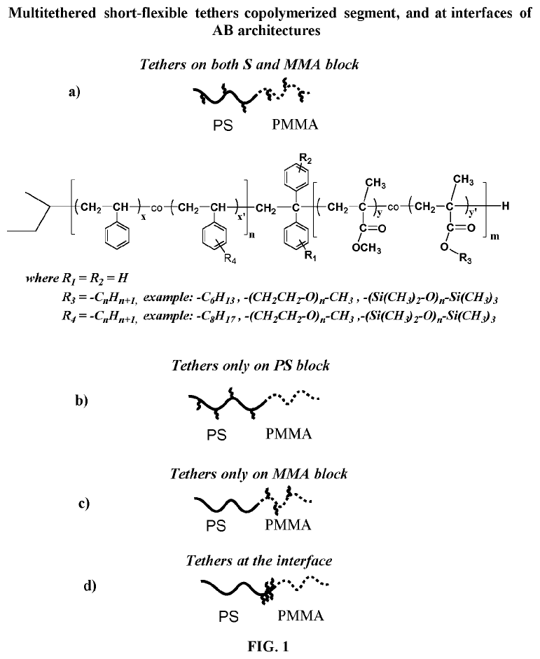

FIG. 1: Representative Example of assembly of novel diblock copolymer of a styrenic monomer and an alkyl methacrylate monomer, wherein at least one of these blocks has a low T_{g} because it is multi-tethered with oligo-flexible group.

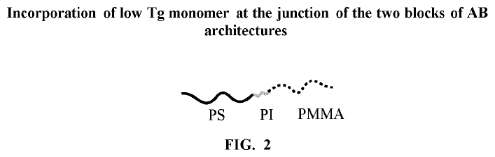

FIG. 2: Representative Example of assembly of novel AB diblock copolymer of polystyrene (PS) and poly(methyl methacrylate) (PMMA) modified by the including of an additional low T_{g} block segment such as one comprising polyisoprene (PI).

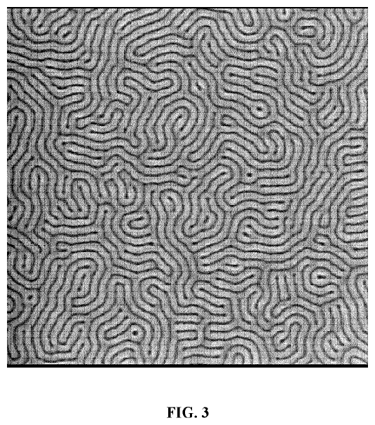

FIG. 3: Fingerprint pattern (FP) of multi-tethered diblock copolymer (EX 2, TAB) on brush Underlayer Neutral Copolymer 1

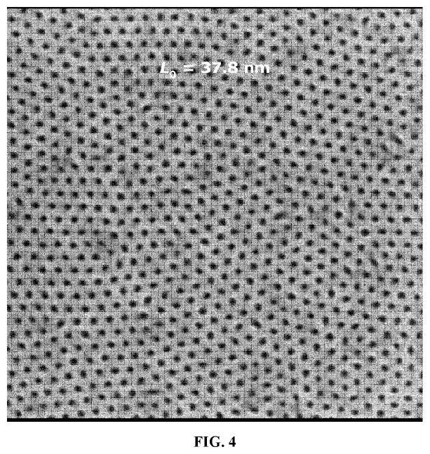

FIG. 4: 1 FOV SEM images, of multi-tethered diblock copolymer (EX 6, TAB 5) Multi-tethered diblock shows improved grain sizes with no defects.

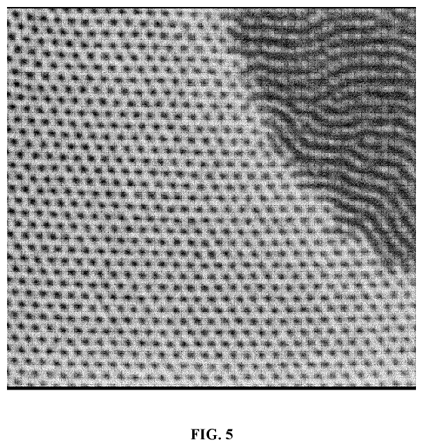

FIG. 5: 1 FOV SEM images, standard CH diblock copolymer (EX 1a, AB1), this standard diblock copolymer shows a large number of defects caused by areas of mixed morphology.

### SUMMARY OF THE INVENTION

Defect free assembly process of block copolymers requires high thermal energy and longer time. This difficulty limits application of directed self-assembly of block copolymer with large domain spacing and the use of triblock copolymer which doubles the molecular weight of diblock copolymers for multi-pitch applications in lithographic patterning. This invention relates to the synthesis of two kinetically enhanced AB di-block copolymer families.

In both approaches the T_{g} of the block segments were lowered aiming at enhancing the kinetic of annealing to reduce the annealing required to achieve defect free assembly during DSA processing. In the first family the AB di-block copolymer comprises at least one block which is multi-tethered with oligo flexible tethered groups. In the second family the AB diblock copolymer comprises a third block which contains a low T_{g} repeat unit such as derived from isoprene and similar low T_{g} olefinic repeat units.

The first approach as illustrated in (FIG. 1) is the development a series of novel multi-tethered copolymerized diblock with low T_{g} comonomers, for example at PS block or in PMMA block or in both PS and PMMA blocks. Non limiting specific examples are, P(S1-co-S2)-b-P(M1-co-M2), P(S1-co-S2)-b-PMMA, and PS-b-P(M1-co-M2), which have a target molecular weight exhibiting narrow molecular weight distribution (PDI<1.1), as follows:
P(S1-co-S2)-b-P(ML-co-M2), is a block copolymer comprising a first block P(S1-co-S2) polymer block comprising two different types of styrenic repeat units and a second polymer block P(M1-co-M2) comprising two different type of methacrylate repeat units, where Si is styrene and S2 is styrene substituted with an oligo flexible tethered groups, M1 is methyl methacrylate and M2 is a methacrylate substituted an with oligo flexible tethered groups
P(S1-co-S2)-b-PM1 is a block copolymer comprising a first block P(S1-co-S2) polymer comprising two different types of styrenic repeat units and a second polymer block PM1 comprising a single type of styrenic repeat units, where S1 is styrene and S2 is styrene substituted with an oligo flexible tethered groups, and M1 is methyl methacrylate
PS1-b-P(M1-co-M2) is block copolymer comprising a first polymer block PS1 comprising a single type of styrenic repeat unit (S1), and a second polymer block P(M1-co-M2) comprising two different types of alkyl methacrylate (M1 and M2), where Si is styrene, and M1 is methyl methacrylate and M2 is a methacrylate substituted an oligo flexible tethered groups.

The other approach (FIG. 2) is to modify a styrenic/alkyl methacrylate AB diblock copolymer to include an additional block segment which has a low T_{g}. For example, in a diblock copolymer PS and PMMA block introduce an additional block segment which has a low T_{g} of about −5° C. to about −50° C. comprising olefin or diene derived repeat units such as, for example, repeat units derived from isoprene (PI) which also have a target molecular weight exhibiting narrow molecular weight distribution (PDI<1.1). A non-limiting example of this type of polymer is PS1-b-PI-b-PMMA as follow:
PS1-b-PI-b-PMMA which is a block copolymer comprising a first polymer block PS1 comprising a single type of styrene repeat unit (S1), and a second polymer block (PI) comprising isoprene repeat units and a third block (PMMA) comprising poly(methyl methacrylate repeat units.

Both modified block copolymers families can be made using living anionic polymerization in the presence of anionic initiators such as s-Bu Li initiator.

More generally, these two types of polymers are inventive polymer families are described by structures (I) and (III) respectively as shown as follows.

### Inventive Polymer of Structure (I)

One aspect of this invention is a block copolymer having structure (I), wherein
A segment is a non-polar block copolymer segment comprising styrenic repeat units,
B segment, is a polar block copolymer segment comprising either alkyl 2-methylenealkanoate derived repeating units, lactone derived repeat units, oxirane derived repeat units, oxetane derived repeating units, or cyclic carbonate derived repeat units;
L is either a direct valence bond or a linking moiety derived from a 1,1-diarylethene
E′ is a C-1 to C-12 alkyl end group,
E″ is an end group selected from H an alkyl, a carbonylalkyl (—C═O-alkyl), a carbonyloxyalkyl (—C═O—O-alkyl, and an alkyl 2-arylacrylate derived end group (—CH₂—CH(Aryl)(C(═O))—O-alkyl).

Further, in this embodiment of block copolymer of structure (1) is multi-tethered with oligo flexible tethered groups which are selected from oligo linear alkylene tethered group, oligo ether tethered groups, and oligo dialkyl siloxane tethered groups, and these oligo flexible tethered groups are multi-tethered on at least one of either the A segments, B segments, and L, if L is a linking moiety derived from a 1,1-diarylethene, and said block copolymer has a polydispersity ranging from 1 to about 1.09, and a Mₙ of at least 40,000.

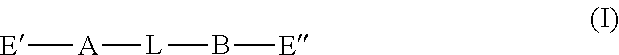

### Inventive Polymer of Structure (III)

A further aspect of this invention is a block copolymer having structure (III), wherein
A₁ is a styrenic block copolymer segment, which has a T_{g} from about 50° C. and to about 100° C.
A₂ is block copolymer segment with a T_{g} ranging from about −5° C. to about −50° C., which comprises repeat units derived from either an olefin selected from the group consisting of an alkene, an alkadiene, and an alkatriene, or a from mixture of at two different olefins selected from this group;
B₁ is a polar block copolymer segment, which has a T_{g} of about 50° C. to about 100° C., comprising either alkyl 2-methylenealkanoate derived repeating units, lactone derived repeat units, oxirane derived repeat units, oxetane derived repeating units, or cyclic carbonate derived repeat units;
L₁ is either a direct valence bond or a linking moiety derived from a 1,1-diarylethene; wherein
E³ is an alkyl,
E⁴ is an groups selected from H, an alkyl, a carbonylalkyl (—C═O-alkyl), a carbonyloxyalkyl (—C═O—O— alkyl, and an alkyl 2-arylacrylate derived end group (—CH₂—CH(Aryl)(C(═O))—O-alkyl).

Further, in this embodiment of block copolymer of structure (III) it has a polydispersity ranging from 1 to about 1.09:

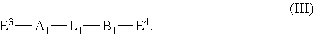

Another aspect of this invention are compositions comprising the inventive block copolymer of structure (I), or the inventive block copolymer of structure (III) and a spin casting solvent.

Another aspect of this invention is the method of using the above-described compositions in a self-assembly process followed by pattern transfer of the self-assembled pattern into a substrate.

### DETAILED DESCRIPTION OF THE INVENTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including,” as well as other forms such as “includes” and “included”, is not limiting. Also, terms such as “element” or “component” encompass both elements and components comprising one unit and elements or components that comprise more than one unit, unless specifically stated otherwise. As used herein, the conjunction “and” is intended to be inclusive and the conjunction “or” is not intended to be exclusive unless otherwise indicated. For example, the phrase “or, alternatively” is intended to be exclusive. As used herein, the term “and/or” refers to any combination of the foregoing elements including using a single element.

L₀ is the natural pitch of assembled block copolymer which tends to be proportional to the size of copolymer.

The term C-1 to C-4 alkyl embodies methyl and C-2 to C-4 linear alkyls and C-3 to C-4 branched alkyl moieties, for example as follows: methyl(—CH₃), ethyl (—CH₂—CH₃), n-propyl (—CH₂—CH₂—CH₃), isopropyl (—CH(CH₃)₂, n-butyl (—CH₂—CH₂—CH₂—CH₃), tert-butyl (—C(CH₃)₃), isobutyl (CH₂—CH(CH₃)₂, 2-butyl (—CH(CH₃)CH₂—CH₃). Similarly, the term C-1 to C-8 embodies methyl, C-2 to C-8 linear, C-3 to C-8 branched alkyls, C-4 to C-8 cycloalkyls (e.g., cyclopentyl, cyclohexyl, etc.) or C-5-C-8 alkylenecycloalkyls (e.g. —CH₂-cyclohexyl, CH₂—CH₂-cyclopentyl etc.

The term C-2 to C-5 alkylene embodies C-2 to C-5 linear alkylene moieties (e.g. ethylene, propylene etc.) and C-2 to C-5 branched alkylene moieties (e.g., —CH(CH₃)—, —CH(CH₃)—CH₂—, etc.).

Di-block and triblock copolymers of styrenic and alkyl 2-methylenealkanoate derived repeat unit moieties useful as components in the inventive compositions described herein may be made by a variety of methods, such as anionic polymerization, atom transfer radical polymerization (ATRP), reversible addition-fragmentation chain transfer (RAFT) polymerization, living radical polymerization and the like (Macromolecules 2019, 52, 2987-2994; Macromol. Rapid Commun. 2018, 39, 1800479; A. Deiter Shluter et al Synthesis of Polymers, 2014, Volume 1, p 315; Encyclopedia of Polymer Science and Technology, 2014, Vol 7, p 625.)

The random copolymer poly(styrene-co-methyl methacrylate) is abbreviated as “P(S-co-MMA),” and the oligomeric version of this materials is abbreviated oligo(S-co-MMA). Similarly, the block copolymer poly(styrene-block-methyl methacrylate) is abbreviated as P(S-b-MMA), while the oligomer of this material is abbreviated as oligo(S-b-MMA). The oligomer oligo(styrene-co-p-octylstyrene)-block-(methyl methacrylate-co-di(ethylene glycol) methyl ether methacrylate) uses the same abbreviations to designate random an block copolymer elements, specifically oligo(S-co-p-OS)-b-P(MMA-co-DEGMEMA), in which S=styrene, p-OS=para-octylstyrene, MMA=methacrylate, DEGMEMA=di(ethylene glycol) methyl ether methacrylate designate the repeat units in this block copolymer whose two blocks are random copolymers.

FOV is the abbreviation for field of view for top-down scanning electron micrographs (SEM) for the SEM FIGs. in this application. “L/S,” is an abbreviation for line and space lithographic features.

The term alkyl 2-methylenealkanoate (alkyl-O—(C═O)—C(alkyl)=CH₂), refers to alkyl esters of a 2-methylenealkanoate, wherein said 2-methylenealkanoate may incorporate up to 11 carbon atoms, and said alkyl in alkyl 2-methylenealkanoate may incorporate up to 8 carbon atoms, selected from methyl, linear alkyls, branched alkyls and cyclic alkyls. The following structures give a general structure for such alkyl 2-methylenealkanoate, where Ralkₐ and Ralk_{b} independently are selected from C-1 to C-8 alkyl groups and show non-limiting examples of alkyl 2-methylenealkanoates falling within this scope.

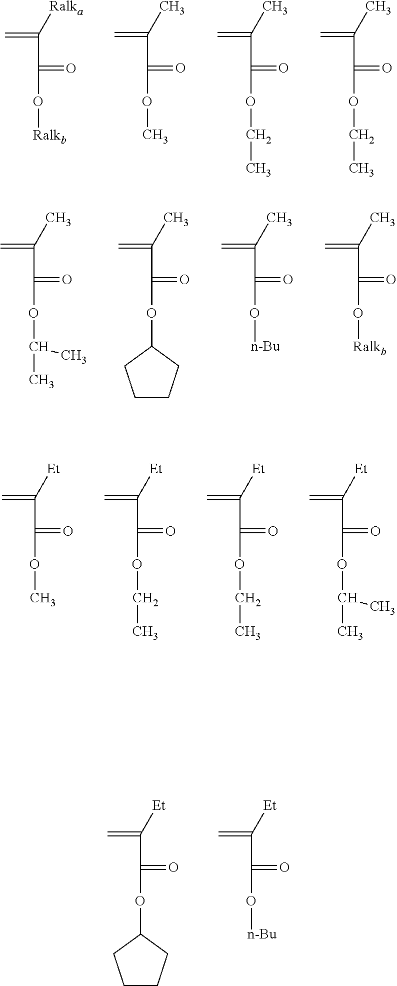

The term styrenic as used herein, unless otherwise indicated, encompasses repeat units derived from styrene derivative generally for examples ones derived from styrene derivatives having the following structure, wherein Xsty moiety is H or a C-1 to C-4 alkyl and the Rsty moiety is H, C-1 to C-5 alkyl, a halide, a C-1 to C-5 alkyloxy or an oligo flexible tethered group, st is the number of Rsty substituents and is 1 or 2.

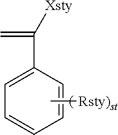

The term 1,1-diarylethene as used herein, unless otherwise indicated, encompasses a moiety derived from ethene which has two substituents at the 1 position which are aryl moieties as shown as follows, where Aryl₁ and Aryl₂ are aryl substituent selected from phenyl, or substituted phenyl, and if the substituents is present in either, or both Aryl₁ and Aryl₂ these substituents are independently selected from a C-1 to C-5 alkyl, a halide, a C-1 to C-5 alkyloxy and an oligo flexible tethered group.

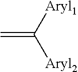

The term “alkyl 2-arylacrylate derived end group,” described with the generic structure (—CH₂—CH(Aryl)(C(═O))—O-alkyl) unless otherwise indicated, is defined in more detail in the general structure below where * indicates the attachment point to the end of a block copolymer chain; Aryl₃ is an aryl substituent selected from phenyl, or substituted phenyl, and if a substituents is present in either, where this substituents are independently selected from a C-1 to C-5 alkyl, a halide, a C-1 to C-5 alkyloxy and an oligo flexible tethered group, and further where alkyl₃ is an unsubstituted alkyl C-1 to C-5 alkyl or a C-1 to C-5 alkyl substituted with an oligo flexible tethered group. This end group structure may be derived, as an illustrative example, by a 2-arylacrylate alkyl ester reacting at the CH₂ olefinic moiety with a living anion at the end of a polymeric chain forming a CH⁻ anion which is then terminated by protonation.

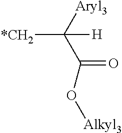

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature references and similar materials defines a term in a manner that contradicts the definition of that term in this application, this application controls.

Unless otherwise indicated, “alkyl” refers to hydrocarbon groups which can be linear, branched (e.g., methyl, ethyl, propyl, isopropyl, tert-butyl and the like) or cyclic (e.g., cyclohexyl, cyclopropyl, cyclopentyl and the like) multicyclic (e.g., norbornyl, adamantyl and the like). These alkyl moieties may be substituted or unsubstituted as described below. The term “alkyl” refers to such moieties with C-1 to C-20 carbons. It is understood that for structural reasons linear alkyls start with C-1, while branched alkyls and cyclic alkyls start with C-3 and multicyclic alkyls start with C-5. Moreover, it is further understood that moieties derived from alkyls described below, such as alkyloxy and perfluoroalkyl, have the same carbon number ranges unless otherwise indicated. If the length of the alkyl group is specified as other than described above, the above-described definition of alkyl still stands with respect to it encompassing all types of alkyl moieties as described above and that the structural consideration with regards to minimum number of carbons for a given type of alkyl group still apply.

Alkyloxy (a.k.a. Alkoxy) refers to an alkyl group on which is attached through an oxy (—O—) moiety (e.g., methoxy, ethoxy, propoxy, butoxy, 1,2-isopropoxy, cyclopentyloxy cyclohexyloxy and the like). These alkyloxy moieties may be substituted or unsubstituted as described below.

Halo or halide refers to a halogen, F, Cl, Br or I which is linked by one bond to an organic moiety.

As used herein the term lactone encompasses both mono-lactones (e.g., caprolactone) and di-lactones (e.g., lactide).

Haloalkyl refers to a linear, cyclic or branched saturated alkyl group such as defined above in which at least one of the hydrogens has been replaced by a halide selected from the group of F, Cl, Br, I or mixture of these if more than one halo moiety is present. Fluoroalkyls are a specific subgroup of these moieties.

Perfluoroalkyl refers to a linear, cyclic or branched saturated alkyl group as defined above in which the hydrogens have all been replaced by fluorine (e.g., trifluoromethyl, pefluoroethyl, prefluoroisopropyl, perfluorocyclohexyl and the like).

The term oligo flexible tethered groups, as used in describing different embodiments of inventive polymers or compounds described herein, refers to a grouping of moieties which includes oligo linear alkylene tethered groups, oligo ether tethered groups and oligo dialkyl siloxane tethered groups.

The term oligo linear alkylene tethered group in the different embodiments of inventive polymers or compounds, described herein, refers in the widest embodiments to groups having the following general structures: —X1-(CH₂)ₐ—CH₃, where a is 6 to 19 and X1 is selected from a direct valence bond, a linear C-1 to C-4 alkylene spacer, —O—, —CH₂—O—, —O—(C═O)—, —C═O—O—, C═O, —CH₂—O—(C═O)—, —S—, —SO₂—, —SO—.

In one embodiment, X1 is a direct valence bond. In another embodiment, X1 is a linear C-1 to C-4 alkylene spacer. In another embodiment X1 is —O—. In still another embodiment it is —CH₂—O—; in still another X1 is —O—(C═O)—. In another embodiment X1 is —C═O—O—. In another embodiment X1 is a carbonyl (C═O). In another embodiment X1 is —CH₂—O—(C═O)—. In another embodiment X1 is —S—. In another embodiment X1 is —SO₂—. In another embodiment X1 is —SO—. More specific types of these groups are —O—(CH₂)ₐ—CH₃, or —CH₂—O—(CH₂)ₐ—CH₃ wherein a is 6 to 19. In more specific embodiments —O—(CH₂)ₐ—CH₃, or —CH₂—O—(CH₂)ₐ—CH₃ have a equal to from 7 to 19. In a still more selective embodiment —O—(CH₂)ₐ—CH₃, or —CH₂—O—(CH₂)ₐ—CH₃ have a equal to from 7 to 10. In a still more selective embodiment —O—(CH₂)ₐ—CH₃, or —CH₂—O—(CH₂)ₐ—CH₃ have a equal to from 8-9. In a still more selective embodiment —O—(CH₂)ₐ—CH₃, or —CH₂—O—(CH₂)ₐ—CH₃ have a equal to 8. In another more specific embodiments —O—(CH₂)ₐ—CH₃, or —CH₂—O—(CH₂)ₐ—CH₃ have a equal to from 7 to 14. In a still more selective embodiment —O—(CH₂)ₐ—CH₃, or —CH₂—O—(CH₂)ₐ—CH₃ have a equal to from 7 to 13. In a still more selective embodiment —O—(CH₂)ₐ—CH₃, or —CH₂—O—(CH₂)ₐ—CH₃ have a equal to from 8-13. In a still more selective embodiment —O—(CH₂)ₐ—CH₃, or —CH₂—O—(CH₂)ₐ—CH₃ have a equal to 13. In another more specific embodiments —O—(CH₂)ₐ—CH₃, or —CH₂—O—(CH₂)ₐ—CH₃ have a equal to from 7 to 19. In a still more selective embodiment —O—(CH₂)ₐ—CH₃, or —CH₂—O—(CH₂)ₐ—CH₃ have a equal to from 8 to 19. In a still more selective embodiment —O—(CH₂)₈—CH₃, or —CH₂—O—(CH₂)ₐ—CH₃ have a equal to from 9 to 19. In a still more selective embodiment —O—(CH₂)ₐ—CH₃, or —CH₂—O—(CH₂)ₐ—CH₃ have a equal to from 10 to 19. In a still more selective embodiment —O—(CH₂)ₐ—CH₃, or —CH₂—O—(CH₂)ₐ—CH₃ have a equal to from 11 to 19. In a still more selective embodiment —O—(CH₂)ₐ—CH₃, or —CH₂—O—(CH₂)ₐ—CH₃ have a equal to from 12 to 19. In a still more selective embodiment —O—(CH₂)ₐ—CH₃, or —CH₂—O—(CH₂)ₐ—CH₃ have a equal to from 13 to 19. In a still more selective embodiment —O—(CH₂)ₐ—CH₃, or —CH₂—O—(CH₂)ₐ—CH₃ have a equal to from 13 to 19. In a still more selective embodiment —O—(CH₂)ₐ—CH₃, or —CH₂—O—(CH₂)ₐ—CH₃ have a equal to from 14 to 19. In a still more selective embodiment —O—(CH₂)ₐ—CH₃, or —CH₂—O—(CH₂)ₐ—CH₃ have a equal to from 15 to 19. In a still more selective embodiment —O—(CH₂)ₐ CH₃, or —CH₂—O—(CH₂)ₐ—CH₃ have a equal to from 16 to 19. In a still more selective embodiment —O—(CH₂)ₐ—CH₃, or —CH₂—O—(CH₂)ₐ—CH₃ have a equal to from 17 to 19. In a still more selective embodiment —O—(CH₂)ₐ—CH₃, or —CH₂—O—(CH₂)ₐ—CH₃ have a equal to from 18 to 19. In a still more selective embodiment —O—(CH₂)ₐ—CH₃, or —CH₂—O—(CH₂)ₐ—CH₃ have a equal to 18. These linear alkylene tethered group may either be unsubstituted or substituted with a C-1 to C-8 alkyl group forming a branching point. These linear alkylene tethered groups may either be unsubstituted or substituted with a C-1 to C-8 alkyl group forming a branching point.

The term oligo ether tethered group in the different embodiments of inventive polymers or compounds, described herein, refers to moieties having the following general structures: —O—[(CH₂)ₑ—O—]ₑ₂—(CH₂)ₑ₃—H, and —(CH₂)ₑ₄—O—[(CH₂)ₑ—O—]ₑ₂—(CH₂)ₑ₃—H, wherein independently e is from 2 to 8, e2 is from 2 to 8, e3 is from 1 to 8, and e4 is from 1 to 8. In one specific embodiment another aspect of this embodiment it is —O—(CH₂—CH₂—O)ₑ₂—(CH₂)ₑ₃—H; in a more specific aspect of this embodiment it is —O—(CH₂—CH₂—O)ₑ₂—(CH₃); in a more specific aspect of this embodiment it is —CH₂—O—(CH₂—CH₂—O)₄—CH₃; in yet another more specific embodiment it is O—(CH₂—CH₂—O)₄—CH₃. In another more specific embodiment, it is —CH₂—O—(CH₂—CH₂—O)ₑ₂—(CH₂)ₑ₃—H. In another more specific embodiment, it is —CH₂—O—(CH₂—CH₂—O)ₑ₂—CH₃, in another more specific aspect of this embodiment it is —CH₂—O—(CH₂—CH₂—O)₄—CH₃, another more specific aspect of this embodiment it is —CH₂—O—(CH₂—CH₂—O)₂—CH₃ These oligo ethers tethered group may either be unsubstituted or substituted with a C-1 to C-8 alkyl group forming a branching point.

The term oligo dialkyl siloxane tethered group present in the different embodiments of inventive polymers or compounds, described herein, refers to groups having the following general structures —X2-[Si(alkyl)₂-O]ₛ-Si(alkyl)₃, where s is from 6 to 18 and the alkyl moiety is a C-1 to C-8 alkyl and X2 is a direct valence bond, or a C-1 to C-8 linear alkylene spacer, or —O—. In a more specific aspect of this embodiment it is —O—[Si(alkyl)₂-O],—Si(alkyl)₃, in a more specific aspect of this embodiment it is —O—[Si(CH₃)₂—O]ₐ—Si(CH₃)₃. In another more specific aspect of this embodiment it is —CH₂—O—[Si(alkyl)₂-O],—Si(alkyl)₃, in a more specific aspect of this embodiment it is —CH₂—O—[Si(CH₃)₂—O]ₛ—Si(CH₃)₃.

### Inventive Polymer of Structure (I)

One aspect of this invention is a block copolymer having structure (I), wherein
A segment is a non-polar block copolymer segment comprising styrenic repeat units;
L is either a direct valence bond or a linking moiety derived from a 1,1-diarylethene;
B segment is a polar block copolymer segment comprising either alkyl 2-methylenealkanoate derived repeating units, lactone derived repeat units, oxirane derived repeat units, oxetane derived repeating units, or cyclic carbonate derived repeat units
E′ is a C-1 to C-12 alkyl end group;
E″ is an end group selected from H an alkyl, a carbonylalkyl (—C═O-alkyl), a carbonyloxyalkyl (—C═O—O-alkyl, and an alkyl 2-arylacrylate derived end group (—CH₂—CH(Aryl)(C(═O))—O-alkyl).

Further, in this embodiment of block copolymer of structure (1) is multi-tethered with oligo flexible tethered groups which are selected from oligo linear alkylene tethered groups, oligo ether tethered groups, and oligo dialkyl siloxane tethered groups, and these oligo flexible tethered groups are multi-tethered on at least one of either the A segments, B segments, and L, if L is a linking moiety derived from a 1,1-diarylethene, and said block copolymer has a polydispersity ranging from 1 to about 1.09, and a Mₙ of at least 40,000.

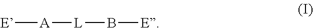

In another embodiment of the block copolymer of structure (I), described herein, said oligo flexible tethered groups are oligo linear alkylene tethered groups.

In another embodiment of the block copolymer of structure (I), described herein, said oligo flexible tethered groups are oligo linear alkylene tethered group having the general structure —X1—(CH₂)ₐ—CH₃, wherein n is 6 to 19 and X1 is and X1 is selected from a direct valence bond, a linear C-1 to C-4 alkylene spacer, —O—, —CH₂—O—, —O—(C═O)—, —C═O—O—, C═O, —CH₂—O—(C═O)—, —S—, —SO₂—, and —SO—.

In another embodiment of the block copolymer of structure (I), described herein, said oligo flexible tethered groups are oligo ether tethered groups.

In another embodiment of the block copolymer of structure (I), described herein, said oligo flexible tethered groups are oligo ether tethered groups, which have the formulas: —O—[(CH₂)ₑ—O—]ₑ₂—(CH₂)ₑ₃—H, or —(CH₂)ₑ₄—O—[(CH₂)ₑ₄—O—]ₑ₂—(CH₂)ₑ₃—H, wherein independently e is from 2 to 8, e2 is from 2 to 8, e3 is from 1 to 8, and e4 is from 1 to 8.

In another embodiment of the block copolymer of structure (I), described herein, said oligo flexible tethered groups are oligo dialkyl siloxane tethered groups.

In another embodiment of the block copolymer of structure (I), described herein, said oligo flexible tethered groups are oligo dialkyl siloxane tethered groups which have the formula —X2-[Si(alkyl)₂-O]ₛ—Si(alkyl)₃, where s is from 6 to 18 and the alkyl moiety is a C-1 to C-8 alkyl and X2 is a direct valence bond, or a C-1 to C-8 linear alkylene spacer, or —O—.

In another embodiment of the block copolymer of structure (I), described herein, said polar block copolymer segment B comprises repeat units derived from a lactone.

In another embodiment of the block copolymer of structure (I), described herein, said polar block copolymer segment B comprises repeat units derived from an alkyl 2-methylenealkanoate.

In another embodiment of the block copolymer of structure (I), described herein, said polar block copolymer segment B segment has a Mw between about 20,000 and about 200,000, and said non-polar styrenic block copolymer segment A has a Mw between 20,000 and about 200,000.

In another embodiment of the block copolymer of structure (I), described herein, L is a direct valence bond.

In another embodiment of the block copolymer of structure (I), described herein, L is a linking group derived from a 1,1-diarylethene.

In another embodiment of the block copolymer of structure (I), described herein, E″ is H.

In another embodiment of the block copolymer of structure (I), described herein, E″ is an alkyl.

In another embodiment of the block copolymer of structure (I), described herein, E″ is a carbonylalkyl (—C═O-alkyl).

In another embodiment of the block copolymer of structure (I), described herein, E″ a carbonyloxyalkyl (—C═O—O-alkyl).

In another embodiment of the block copolymer of structure (I), described herein, E″ is an alkyl 2-arylacrylate derived end group (—CH₂—CH(Aryl)(C(═O))—O-alkyl).

In another embodiment of the block copolymer of structure (I), described herein, said oligo flexible tethered groups are located on the A segments and are either randomly located along this segment on some of its repeat units or present on each of its repeat units.

In another embodiment of the block copolymer of structure (I), described herein, said oligo flexible tethered groups are located on the B segment and are either randomly located along this segment on some of its repeat units or present on each of its repeat units.

In another embodiment of the block copolymer of structure (I), described herein, said oligo flexible tethered groups are located on the linking group L, when it is derived from a 1,1-diarylethene.

In another embodiment of the block copolymer of structure (I), described herein, said oligo flexible tethered groups are located on the A segment, the B segment, and the linking group L, if L is derived from a 1,1-diarylethene and are either randomly located along A segment or B Segment on some of their respective repeat units or present on each of their respective repeat units.

In another embodiment of the block copolymer of structure (I), described herein, said oligo flexible tethered groups are only located on the A segment and are either randomly located along this segment, on some of its repeat units, or present on each of its repeat units.

In another embodiment of the block copolymer of structure (I), described herein, said oligo flexible tethered groups are only located on the B segment and are either randomly located along this segment, on some of its repeat units, or present on each of its repeat units.

In another embodiment of the block copolymer of structure (I), described herein, wherein said oligo flexible tethered groups are only located on the linking group L, if L is derived from a 1,1-diarylethene.

In another embodiment of the block copolymer of structure (I), described herein, said oligo flexible tethered groups are only located on the A segment and the B segment and are either randomly located along A segment and B segment, on some of their respective repeat units, or present on each one of their respective repeat units.

In another embodiment of the block copolymer of structure (I), described herein, said oligo flexible tethered groups are only located on both the A segment and the linking group L if it is derived from a 1,1-diarylethene and are either randomly located along the A segment, on some of its repeat units, or present on each of its repeat units

In another embodiment of the block copolymer of structure (I), described herein, wherein said oligo flexible tethered groups are only located on the B segment and the linking group L, if L is derived from a 1,1-diarylethene and are either randomly located along the B segment, on some of its repeat units, or present on each of its repeat units.

In another embodiment of the block copolymer of structure (I), described herein, wherein said oligo flexible tethered groups are present on either A segment or B segment, or both, these oligo flexible tethered groups are present randomly along their respective segments on some of their repeat units.

In another embodiment of the block copolymer of structure (I), described herein, wherein said oligo flexible tethered groups are present on either A segment or B segment, or both, these oligo flexible tethered groups are present on all of their respective repeat units.

In another embodiment of the block copolymer of structure (I), described herein, said copolymer has structure (II), comprising
a styrenic block consisting of the randomly copolymerized styrenic repeat units of structures (STa) and (STb) wherein R₁ and R₂ are individually selected from H or a C-1 to C-4 alkyl, and R₅ and R₆ are individually selected from H, a C-1 to C-4 alkyl and an oligo flexible tethered group which is selected from
   an oligo linear alkylene tethered group,
   an oligo ether tethered groups, and
   an oligo dialkyl siloxane tethered groups, a linking moiety of structure (L1), wherein R₇ and R₈ are individually selected from H, a C-1 to C-4 alkyl and a is multi-tethered with oligo flexible tethered group which is selected from
   an oligo linear alkylene tethered group,
   an oligo ether tethered groups, and
   an oligo dialkyl siloxane tethered groups,
a 2-methylenealkanoate derived block consisting of the randomly copolymerized 2-methylenealkanoate repeat units of structures (MEAa) and (MEAb), wherein R₃ and R₄ and individually selected from a C-1 to C-4 alkyl and R₉ and R₁₀ are individually selected from a C-1 to C-4 alkyl and is multi-tethered with oligo flexible tethered group which is selected from
   an oligo linear alkylene tethered group,
   an oligo ether tethered groups, and
   an oligo dialkyl siloxane tethered groups,
E′ is a C-1 to C-12 alkyl end group,
E″ is selected from H an alkyl, a carbonylalkyl (—C═O-alkyl), a carbonyloxyalkyl (—C═O—O-alkyl, and an alkyl 2-arylacrylate derived end group (—CH₂—CH(Aryl)(C(═O))—O-alkyl);
x and x′ designate respectively the number of repeat units of structures (STa) and (STb) in said styrenic block having a Mw from about 20,000 to about 200,000, and in this non-polar block segment it is delineated by the parenthesis designated by n,
y and y′ designate respectively the number of repeat units of structures (MEAa) and (MEAb) in said 2-methylenealkanoate derived block having a Mw from about 20,000 to about 200,000, and in this polar block segment it is delineated by the parenthesis designated by m, and further wherein at least one of structures (STa), (STb), (L1), (MEAa) and (MEAb), respectively, have R₅, R₆, R₇, R₈, R₉ or R₁₀ is selected from said oligo flexible tethered group.

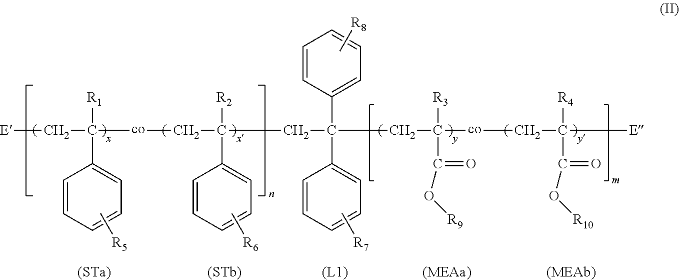

In another embodiment of the block copolymer of structure (II), described herein, R₅ is an oligo flexible tethered group, R₆ is H or a C-1 to C-4 alkyl, R₇ and R₈ are individually selected from H and a C-1 to C-4 alkyl, R₉ and R₁₀ are individually selected from a C-1 to C-4 alkyl.

In another embodiment of the block copolymer of structure (II), described herein, R₅ and R₆ are multi-tethered with oligo flexible tethered groups, R₇ and R₈ are individually selected from H and a C-1 to C-4 alkyl, R₉ and R₁₀ are individually selected from a C-1 to C-4 alkyl.

In another embodiment of the block copolymer of structure (II), described herein, R₅ and R₆ are individually selected from H and a C-1 to C-4 alkyl, at least one of R₈ and R₇ is an oligo flexible tethered group and R₉ and R₁₀ are individually selected from a C-1 to C-4 alkyl. In another aspect of this embodiment both R₈ and R₇ are an oligo flexible tethered group.

In another embodiment of the block copolymer of structure (II), described herein, R₅ and R₆ are individually selected from H and a C-1 to C-4 alkyl, R₈ and R₇ are individually selected from H and a C-1 to C-4 alkyl, and at least one of R₉ and R₁₀ is an oligo flexible tethered group.

In another embodiment of the block copolymer of structure (II), described herein, both R₉ and R₁₀ are oligo flexible tethered groups.

In another embodiment of the block copolymer of structure (II), described herein, R₅ and R₆ are individually selected from H and a C-1 to C-4 alkyl, at least one of R₈ and R₇ is a is an oligo flexible tethered group and R₉ and R₁₀ are individually selected from a C-1 to C-4 alkyl. In another aspect of this embodiment both R₈ and R₇ are an oligo flexible tethered group. In another aspect of this embodiment, at least one of R₅ and R₆, and at least one of R₉ and R₁₀ is a flexible tethered group. In another aspect of this embodiment both R₅ and R₆, and both R₉ and R₁₀ is a flexible tethered group.

In another embodiment of the block copolymer of structure (II), described herein, R₅ and R₆ are individually selected from H and a C-1 to C-4 alkyl, at least one of R₈ and R₇ is a is an oligo flexible tethered group and R₉ and R₁₀ are individually selected from a C-1 to C-4 alkyl. In another aspect of this embodiment both R₈ and R₇ are oligo flexible tethered groups.

In another embodiment of the block copolymer of structure (II), described herein, at least one of R₅ and R₆, at least one of R₇ and R₈ and at least one of R₉ and R₁₀ is a flexible tethered group. In another aspect of this embodiment R₅, R₆, R₇, R₈, R₉ and R₁₀ are oligo flexible tethered groups.

In any one of the embodiment of the block copolymer of structure (II), described herein, where R₅ and R₆ are individually selected from H and a C-1 to C-4 alkyl, at least one of R₈ and R₇ is a is an oligo flexible tethered group and R₉ and R₁₀ are individually selected from a C-1 to C-4 alkyl. In another aspect of this embodiment both R₈ and R₇ are a oligo flexible tethered group, said block copolymer also has R₁ and R₂ are H and in addition R₃ and R₄ are a C-1 to C-3 alkyl. In another aspect of this embodiment R₃ and R₄ are a C-1 to C-2 alkyl. In another aspect of this embodiment R₃ and R₄ are methyl.

Another aspect of this invention is a block copolymer having structure (III), is one wherein
A₁ is a styrenic block copolymer segment, which has a T_{g} from about 50° C. to about 100° C.
A₂ is block copolymer segment with a T_{g} ranging from about −5° C. to about −50° C., which comprises repeat units derived from either an olefin selected from the group consisting of an alkene, an alkadiene, and an alkatriene, or a from mixture of at least two different olefins selected from this group;
B₁ is a polar block copolymer segment, which has a T_{g} of about 50° C. to about 100° C., comprising either alkyl 2-methylenealkanoate derived repeating units, lactone derived repeat units, oxirane derived repeat units, oxetane derived repeating units, or cyclic carbonate derived repeat units;
L₁ is either a direct valence bond or a linking moiety derived from a 1,1-diarylethene; wherein
E³ is an alkyl,
E⁴ is a group selected from H, an alkyl, a carbonylalkyl (—C═O-alkyl), a carbonyloxyalkyl (—C═O—O-alkyl, and an alkyl 2-arylacrylate derived end group (—CH₂—CH(Aryl)(C(═O))—O-alkyl), and further wherein
said block copolymer has a polydispersity ranging from 1 to about 1.09;

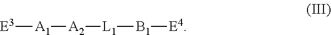

In another embodiment of the block copolymer of structure (III), described herein, said A₂ has repeat units derived from an alkene.

In another embodiment of the block copolymer of structure (III), described herein, said A₂ has repeat units derived from an alkadiene. In another aspect of this said alkadiene is a conjugated diene.

In any one of the above embodiments of the block copolymer of structure (III), described herein, said A₂ comprises a mixture of at least two different repeat units having structures (IIIa), (IIIb), (IIIc), and (IIId), derived from an alkadiene; wherein R_{d}, R_{d1}, R_{d3}, R_{d4}, Rₑ, Rₑ₁, Rₑ₃, and Rₑ₄, are individually selected from the group consisting of a H, and a C-1 to C-8 alkyl, and further wherein the total mole % of olefinic repeat units in said block copolymer ranges from about 3 mole % to about 50 mole %. In another aspect of this embodiment, R_{d}, R_{d1}, R_{d3}, and R_{d4} are the same and are selected from a H, or a C-1 to C-8 alkyl, and Rₑ, Rₑ₁, Rₑ₃ and Rₑ₄, are selected from a H, or a C-1 to C-8 alkyl,

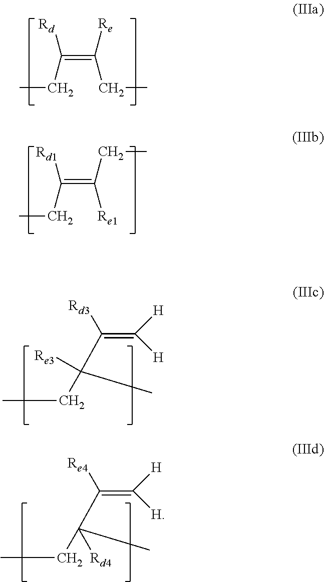

In another embodiment of the block copolymer of structure (III), described herein, A₂ comprises repeat units derived from either ethylene, propylene, butylene, pentylene, hexylene, heptylene, octylene, isoprene, 3-methylenepent-1-ene, 3-methylenehex-1-ene, 3,4-dimethylenehexane, 2-methyl-3-methylenepent-1-ene, 1,3-butadiene, ethylidene norbornene (2-ethylidene-5-norbornene), dicyclopentadiene, vinyl norbornene (2-vinylbicyclo[2.2.1]hept-2-ene), or chloroprene(2-chlorobuta-1,3-diene), or a mixture of at least two of these.

In another embodiment of the block copolymer of structure (III), described herein, wherein said repeat units in A₂ are derived from an alkadiene which is an unconjugated diene.

In another embodiment of the block copolymer of structure (III), described herein, said repeat units in A₂ are derived from an alkatriene.

In another embodiment of the block copolymer of structure (III), described herein, A₂ has repeat units derived from a mixture of at least 2 different olefins selected from the group consisting of an alkene, an alkadiene, and an alkatriene.

In any one of embodiments of the block copolymer of structure (III), described herein, wherein said A₂ may further comprises styrenic repeat units.

In any one of embodiments of the block copolymer of structure (III), described herein, said polar block copolymer segment B₁ comprises repeat units derived from a lactone.

In any one of embodiments of the block copolymer of structure (III), described herein, said polar block copolymer segment B₁ comprises alkyl 2-methylenealkanoate derived repeating units.

In any one of embodiments of the block copolymer of structure (III), described herein, said polar block copolymer segment B₁ has a Mw between about 20,000 and about 200,000 and said non-polar styrenic block segment has a Mw between 20,000 and about 200,000.

In one of the embodiments of the block copolymer of structure (III), described herein, wherein L₁ is a direct valence bond.

In another of the embodiments of the block copolymer of structure (III), described herein, L₁ is a linking group derived from a 1,1-diarylethene.

In another of the embodiments of the block copolymer of structure (III), described herein, E⁴ is either H or an alkyl.

In another of the embodiments of the block copolymer of structure (III), described herein, E⁴ is a group derived from an alkylmethyl-2-arylacrylate.

In another of the embodiments of the block copolymer of structure (III), described herein, E³ is an alkyl

In one of the embodiments of the block copolymer of structure (III), it has the more specific structure (IIIe), comprising
a styrenic block consisting of the randomly copolymerized styrenic repeat units of structures (STc) and (STc) wherein R₁ₐ and R₂ₐ are individually selected from H or a C-1 to C-4 alkyl, R₅ₐ and R₆ₐ are individually selected from H or a C-1 to C-4 alkyl,
a linking moiety of structure (L₁), wherein R₇ₐ and R₈ₐ are individually selected from H, and a C-1 to C-4 alkyl,
E′ is a C-1 to C-12 alkyl end group,
E″ is selected from H an alkyl, a carbonylalkyl (—C═O-alkyl), a carbonyloxyalkyl (—C═O—O-alkyl, and an alkyl 2-arylacrylate derived end group (—CH₂—CH(Aryl)(C(═O))—O-alkyl);
x and x′ designate respectively the number of repeat units of structures (STc) and (STd) in said styrenic block having a Mw from about 20,000 to about 200,000, in the non-polar block segment delineated by the parenthesis designated by n,
y and y′ designate respectively the number of repeat units of structures (MEAc) and (MEAd) in said a 2-methylenealkanoate derived block having a Mw from about 20,000 to about 200,000, in the polar block segment delineated by the parathesis designated by m, where R₃ₐ, R₄ₐ, R₉ₐ and R₁₀ₐ are individually selected from a C-1 to C-4 alkyl,
A₂ is a block copolymer segment with a T_{g} ranging from about −5° C. to about −50° C., which comprises repeat units derived from either an olefin selected from the group consisting of an alkene, an alkadiene, and an alkatriene, or a from mixture of at two different olefins selected from this group;

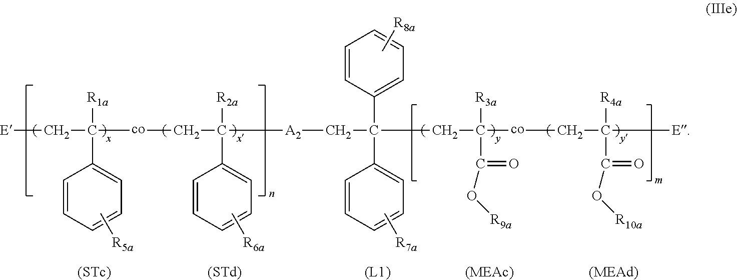

In one of the embodiments of the block copolymer of structure (IIIe), R₁ₐ, R₂ₐ, R₅ₐ R₆ₐ, are H.

In one of the embodiments of the block copolymer of structure (IIIe), R₇ₐ, and R₅ₐ, are H.

In another of the embodiments of the block copolymer of structure (IIIe), R₃ₐ, R₄ₐ, R₉ₐ and R₁₀ₐ are CH₃.

In any one of the embodiment of the block copolymer of structure (IIIe), said A₂ comprises a mixture of at least two different repeat units having structures (IIIa), (IIIb), (IIIc), and (IIId); wherein R_{d}, R_{d1}, R_{d3}, R_{d4}, Rₑ, Rₑ₁, Rₑ₃, and Rₑ₄, are individually selected from the group consisting of a H, and a C-1 to C-8 alkyl, and further wherein the total mole % of olefinic repeat units in said block copolymer ranges from about 3 mole % to about 50 mole %.

In one embodiment of the block copolymer of structure (IIIe), R_{d}, R_{d1}, R_{d3}, and R_{d4} are the same and are selected from a H, or a C-1 to C-8 alkyl, and. Rₑ, Rₑ₁, Rₑ₃, and Rₑ₄, are selected from a H, or a C-1 to C-8 alkyl,

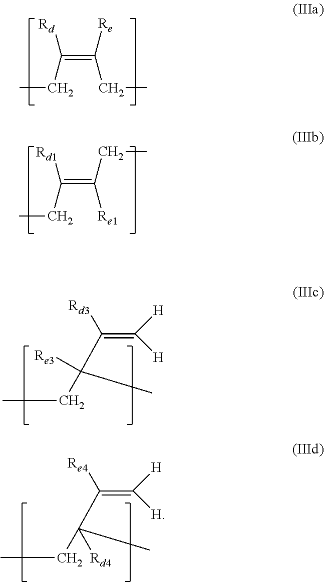

In one of the embodiment of the block copolymer of structure (IIIe) described herein, said A₂ is a block copolymer segment whose repeat units are derived from isoprene or butadiene.

In one of the embodiment of the block copolymer of structure (IIIe) described herein, said non-polar block copolymer segment A₁ has a Mw between about 20,000 and about 200,000.

In one of the embodiment of the block copolymer of structure (IIIe) described herein, E′ is a C-3 to C-7 alkyl.

In one of the embodiment of the block copolymer of structure (IIIe) described herein, E″ is H.

Another aspect of this invention is a composition comprising any of the block copolymers of structure (I) (or its substructure), described herein, and a spin casting organic solvent.

In one aspect of the composition comprising a block copolymer of structures (I), it further comprises another block copolymer.

In one aspect of the composition comprising a block copolymer of structures (I), it further comprises a homopolymer.

Another aspect of this invention is a composition comprising the block copolymer of structure (III), (or its substructure), and a solvent.

Another aspect of this invention is a composition comprising the block copolymer of structure (III), (or its substructure) further comprising another block copolymer.

Another aspect of this invention is a composition comprising the block copolymer of structure (III), (or its substructure) further comprising a homopolymer.

In the inventive composition described herein, comprising a copolymer of structure (I) or of structure (III), (or their more specific substructures as described herein), the spin casting solvent, in one embodiment, is selected from an organic spin casting which is a suitable solvent for dissolving the above-described inventive compositions include. a glycol ether derivative such as ethyl cellosolve, methyl cellosolve, propylene glycol monomethyl ether (PGME), diethylene glycol monomethyl ether, diethylene glycol monoethyl ether, dipropylene glycol dimethyl ether, propylene glycol n-propyl ether, or diethylene glycol dimethyl ether; a glycol ether ester derivative such as ethyl cellosolve acetate, methyl cellosolve acetate, or propylene glycol monomethyl ether acetate (PGMEA); carboxylates such as ethyl acetate, n-butyl acetate and amyl acetate; carboxylates of di-basic acids such as diethyloxylate and diethylmalonate; dicarboxylates of glycols such as ethylene glycol diacetate and propylene glycol diacetate; and hydroxy carboxylates such as methyl lactate, ethyl lactate (EL), ethyl glycolate, and ethyl-3-hydroxy propionate; a ketone ester such as methyl pyruvate or ethyl pyruvate; an alkoxycarboxylic acid ester such as methyl 3-methoxypropionate, ethyl 3-ethoxypropionate, ethyl 2-hydroxy-2-methylpropionate, or methylethoxypropionate; a ketone derivative such as methyl ethyl ketone, acetyl acetone, cyclopentanone, cyclohexanone or 2-heptanone; a ketone ether derivative such as diacetone alcohol methyl ether; a ketone alcohol derivative such as acetol or diacetone alcohol; a ketal or acetal like 1,3 dioxalane and diethoxypropane; lactones such as butyrolactone; an amide derivative such as dimethylacetamide or dimethylformamide, anisole, and mixtures thereof.

Additionally, the above described inventive compositions may further comprise additives selected from the group consisting of surfactants, inorganic-containing polymers; additives including small molecules, inorganic-containing molecules, surfactants, photoacid generators, thermal acid generators, quenchers, hardeners, cross-linkers, chain extenders, and the like; and combinations comprising at least one of the foregoing, wherein one or more of the additional components and/or additives co-assemble with the block copolymer to form the block copolymer assembly.

Another aspect of this invention is a method of vertically orienting first and second block copolymer domains over an unpatterned substrate using a layer of a block copolymer having a periodicity of L₀ comprising the steps of
a) forming a coating layer of a block copolymer from any of the compositions comprising a block copolymer of structure (I), described herein, on said unpatterned substrate; and
b) annealing the layer of the block copolymer to generate a non-zero positive integer number of first and second block copolymer domains, vertically oriented on said unpatterned substrate.

Another aspect of this invention is a method of vertically orienting first and second block copolymer domains over a first patterned substrate where the height of topography of the pattern on the substrate is at least 0.7 times L₀ and aligning the domains with the pattern, using a coating comprising a block copolymer having a periodicity of L₀ comprising the steps of
a1) forming a coating layer of a block copolymer from any of the compositions comprising a block copolymer of structure (I), described herein, on said first topographical substrate, wherein the thickness of the average thickness of the coating layer of the block copolymer is less than the height of the topography of the first topographical substrate, wherein the block copolymer layer is laterally confined by the topography; and
b1) annealing the block copolymer layer to generate first and second block copolymer domains, vertically oriented on said first patterned substrate, and confined within the recessed region.

Another aspect of this invention method of vertically orienting, first and second block copolymer domains with a periodicity of L₀ over a second patterned substrate having a topographical pattern with the height of topography larger than 0.7 times L₀ and a pitch P1 where the pitch P1 is a non-zero positive integer multiplied by L₀, and aligning the domains with the pattern comprising the steps of
a2) forming a coating layer of a block copolymer from any of the compositions comprising a block copolymer of structure (I), described herein, on said second patterned substrate, where the thickness of the coating layer of the block copolymer is more than the height of the topography of the second patterned substrate; and
b2) annealing the block copolymer layer to generate a non-zero positive integer number of first and second block copolymer domains vertically oriented on said second patterned substrate and aligning them to the second patterned substrate where the sum of vertically oriented domains is equal or larger than the pitch P1 the of topographical pattern.

Another aspect of this invention method of vertically orienting first and second block copolymer domains over a substrate having a surface chemical prepattern having a pitch P2, where the pitch P2 is a non-zero positive integer multiplied by L₀ and aligning the domains comprising the steps of
a3) forming a coating layer of a block copolymer from any of the compositions comprising a block copolymer of structure (I), described herein, on the substrate having a surface chemical prepattern; and
b3) annealing the block copolymer layer to generate vertically oriented first and second block copolymer domains aligned with the substrate having a surface chemical prepattern having a pitch P2.

Another aspect of this invention is a method of vertically orienting first and second block copolymer domains over an unpatterned substrate using a layer of a block copolymer having a periodicity of L₀ comprising the steps of
a4) forming a coating layer of a block copolymer from any of the compositions comprising a block copolymer of structure (III), described herein, on said unpatterned substrate; and
b4) annealing the layer of the block copolymer to generate a non-zero positive integer number of first and second block copolymer domains, vertically oriented on said unpatterned substrate.

Another aspect of this invention is a method of vertically orienting first and second block copolymer domains over a first patterned substrate where the height of topography of the pattern on the substrate is at least 0.7 times L₀ and aligning the domains with the pattern, using a coating comprising a block copolymer having a periodicity of L₀ comprising the steps of
a5) forming a coating layer of a block copolymer from any of the compositions comprising a block copolymer of structure (III), described herein, on said first topographical substrate, wherein the average thickness of the coating layer of the block copolymer is less than the height of the topography of the first topographical substrate, wherein the block copolymer layer is laterally confined by the topography; and
b5) annealing the block copolymer layer to generate first and second block copolymer domains, vertically oriented on said first patterned substrate, and confined within the recessed region.

Another aspect of this invention method of vertically orienting, first and second block copolymer domains with a periodicity of L₀ over a second patterned substrate having a topographical pattern with the height of topography larger than 0.7 times L₀ and a pitch P1 where the pitch P1 is a non-zero positive integer multiplied by L₀, and aligning the domains with the pattern comprising the steps of
a6) forming a coating layer of a block copolymer from any of the compositions comprising a block copolymer of structure (III), described herein, on said second patterned substrate, where the thickness of the coating layer of the block copolymer is more than the height of the topography of the second patterned substrate; and
b6) annealing the block copolymer layer to generate a non-zero positive integer number of first and second block copolymer domains vertically oriented on said second patterned substrate and aligning them to the second patterned substrate where the sum of vertically oriented domains is equal or larger than the pitch P1 the of topographical pattern.

Another aspect of this invention method of vertically orienting first and second block copolymer domains over a substrate having a surface chemical prepattern having a pitch P2, where the pitch P2 is a non-zero positive integer multiplied by L₀ and aligning the domains comprising the steps of
a7) forming a coating layer of a block copolymer from any of the compositions comprising a block copolymer of structure (III), described herein, on the substrate having a surface chemical prepattern; and
b7) annealing the block copolymer layer to generate vertically oriented first and second block copolymer domains aligned with the substrate having a surface chemical prepattern having a pitch P2.

### EXAMPLES

### Chemicals

All chemicals unless otherwise indicated were purchased from Sigma Aldrich (3050 Spruce St., St. Louis, MO 63103). Chemicals used in anionic polymerization were purified as described in the literature (e.g., Techniques in High-Vacuum Anionic Polymerization” by David Uhrig and Jimmy Mays and Journal of Polymer Science: Part A: Polymer Chemistry, Vol. 43, 6179-6222 (2005))

Phenyl acrylate derivatives were synthesized by esterification of acryloyl chloride with corresponding hydroxyl compound under basic condition and DPE derivatives were synthesized by alkoxylation of DPE-(m)-CH₂Br (1-(bromomethyl)-3-(1-phenylvinyl)benzene) with corresponding hydroxyl compound under basic condition.

All synthetic experiments were carried out under N₂ atmosphere. Lithographic experiments were carried out as described in the text. The molecular weight of the copolymers was measured with a Gel Permeation Chromatograph. Gel permeation chromatography equipped with 100 Å, 500 Å, 10³ Å, 10⁵ Å and 10⁶ Å μ-ultrastyragel columns

Lithographic Experiments were done using a TEL Clean ACT8 track. SEM pictures were taken with an applied Materials NanoSEM_3D Scanning electron microscope picture are shown at either 1 FOV magnification or 2 FOV magnification (Field of view (FOV)=5 m).

Etching experiments were done using standard isotropic oxygen etching conditions for self-assembled films block copolymer of methyl methacrylate and styrene.

Unless otherwise indicated Molecular weight measurements (a.k.a. Mₙ polydispersity) were done by Gel permeation chromatography (PSS Inc. Germaby) equipped with 100 Å, 500 Å, 10³ Å, 10⁵ Å and 10⁶ Å μ-ultrastyragel columns using THF solvent as an eluent. Polystyrene polymer standards were used for calibration.

DSC measurement of glass transition temperature were done using a TA instrument DSC Q 1000 under nitrogen with a heating rate of 10° C./min. The glass transition temperature (T_{g}) was measured in first heating scan from 0 to 300° C. The midpoint of endothermic transition was considered

¹H NMR spectra were recorded using Bruker Advanced III 400 MHz spectrometer.

The molecular weight of the copolymers was measured with a Gel Permeation Chromatograph. Chemicals, unless otherwise indicated, were obtained from the Sigma-Aldrich Corporation.

These newly developed modified diblock's were tested for finger-print morphology over neutral underlayer brushed substrate on SiOx. In order to evaluate the new novel diblock copolymers, we also developed thick film finger-print network defects analysis method wherein we coat these block copolymer at 2 and 3×Lo and partially dry etch (with oxygen plasma) to identify and count network defects in the bulk of the film. These results are compared with regular diblock, the modified multi-tethered diblock copolymers showed very less defects and faster kinetics. The synthesis of these polymers was accomplished via living anionic copolymerization, the described diblock copolymer exhibits a narrow molecular weight distribution (Mw/Mn<1.1) and works with normal underlayers that are suitable for PS-b-PMMA DSA.

### Underlayer Neutral Copolymer 1:

Copolymer of Styrene, Methyl Methacrylate and 4-Vinylbenzycylobutene Synthesized with AIBN

A 2000-ml flask equipped with a condenser, temperature controller, heating mantle and mechanical stirrer were set up. 87.0 grams (0.84 moles) of styrene(S), 139.8 grams (1.40 moles) of methyl methacrylate (MMA), 72.4 grams (0.56 moles) of 4-Vinylbenzocyclobutene (VBCB) and 1.83 grams (0.011 moles) of Azobisisobutyronitrile (AIBN) initiator and 600 grams of anisole were added to the flask. The mechanical stirrer was turned on and set up at about 120 rpm. The reaction solution was then degassed by vigorously bubbling nitrogen through the solution for about 30 minutes at room temperature. After 30 minutes of degassing the heating mantle was turned on and the temperature controller was set at 70° C., and the stirred reaction mixture was maintained at this temperature for 20 hours. After this time the heating mantle was turned off and the reaction solution was allowed to cool down to about 40° C. Then the reaction mixture was poured into 12 L of isopropanol stirred with a mechanical stirring during the addition. During this addition, the polymer was precipitated out. The precipitated polymer was collected by filtration. The collected polymer was dried in vacuum oven at 40° C. About 170 grams of the polymer was obtained. This dried polymer was dissolved in 600 grams of THF and then filtered through a 0.2 um nylon filter. The filtered solution was then precipitated again into a stirred solution of 12 L methanol, the precipitated polymer collected and dried as before under vacuum at 40° C. In this manner, 150 grams (50% yields) of the polymer was obtained after dry. The polymer had an M_{w} of about 38k and a polydispersity (PDI) of 1.5.

### Reference Block Copolymer Synthesis Example 1 Synthesis of PS-b-PMMA)

PS-b-PMMA was synthesized using the same procedure as described in example 2. To achieve target Mₙ and compositions of PS and PMMA block, the amount of initiator and monomer quantities were changed. Briefly, 20 g (192 mmol) of styrene was polymerized with 0.31 mL (1.4M solution) of sec-butyllithium. Then 0.09 g (0.50 mmol) of 1,1′-diphenylethylene (DPE) in 2.5 ml of dry toluene was added via ampule into the reactor. The orange color of the reaction mixture turned into dark brick-red indicating conversion of styryl lithium active centers to delocalized DPE adduct carbanion. After 2 min of stirring, a small amount (2 mL) of the reaction mixture was withdrawn for PS block molecular weight analysis. Then methyl methacrylate (22.85 g, 230 mmol) was added via ampule. The reaction was terminated after 30 min with 1 mL of degassed methanol. The block copolymer was recovered by precipitation in excess isopropanol (5 times of the polymer solution) containing 10% water, filtered, and dried at 55° C. for 12 h under vacuum giving 40 g of P(S-b-MMA) (94% yield) consisting of 46.9 mol. % of polystyrene block and 53.1 mol. % of polymethylmethacrylate block. The diblock copolymer molecular weight obtained from GPC is Mₙ=92K, PDI=1.02).

### Reference Block Copolymer Synthesis Example 1a Synthesis of CH (PS-b-PMMA)

The same procedure was used as Example 1, except that 69 mol % of polystyrene block and 31 mol % of polymethylmethacrylate block. The diblock molecular weight obtained from GPC is Mₙ=66.92K, PDI=1.01).

### Synthesis of Novel Modified AB Diblock Copolymers

The diblock copolymers described were unique and in not requiring matching underlayers for perpendicular orientation. These are novel kinetically enhanced diblock copolymers compared to regular diblock copolymers.

### Synthesis Example 2 TAB-1 (Line and Space)

This system demonstrates the synthesis of P(S-co-C8S)-b-P(MMA-co-C6MA) with low T_{g} octyl styrene copolymerized in PS block and hexyl methacrylate copolymerized in PMMA block (TAB):

Styrene, octyl styrene, methyl methacrylate and hexyl methacrylate monomers were distilled in the presence of dehydrating agents into calibrated ampules and stored under N₂. Liquids were transferred into the reactor either via ampule or using stainless steel cannula under N₂. Into a dry 1 L round bottom reactor equipped with side arms for connecting ampules, magnetic stir bar, nitrogen/vacuum three-way septum adapter, was added 500 mL dry tetrahydrofuran and 0.35 g of LiCl. The temperature of the reactor was reduced to −78° C. using dry ice-acetone bath. Then, after titrating the impurities, 3.6 mL (0.103 M solution) of s-BuLi as the initiator was added into the reactor. Then a mixer of 3.3 g (0.0152 moles) of n-octyl styrene and 14.23 g (0.137 moles) of styrene was added from the ampule into the reactor under fast stirring. The reaction mixture turned orange-red and the reaction was continued for 30 minutes. Subsequently, 0.08 g (0.00044 moles) of 1,1′-diphenylethylene was added via ampule into the reactor. The orange color of the reaction mixture turned into dark brick-red indicating conversion of styryl potassium active centers to styrene-DPE carbanion. A small amount (2 mL) of the reaction mixture was withdrawn for P(S-co-C8S)-DPE block molecular weight analysis. Then the mixture of methyl methacrylate (14.8 g, 0.148 moles) and hexyl methacrylate (2.80 g, 0.0165 moles) was added via ampule. The reaction was continued for 50 minutes to complete polymerization of MMA and C6MA. The reaction mixture was then terminated with 1 mL of degassed methanol. The block copolymer was recovered by precipitation in excess isopropanol (5 times of the polymer solution) containing 10% water, filtered, and dried at 70° C. for 12 h under vacuum giving 30 g of P(S-co-C8S)-b-P(MMA-co-C6MA) (95% yield). Gel permeation chromatography equipped with 100 Å, 500 Å, 10³ Å, 10⁵ Å and 10⁶ Å μ-ultrastyragel columns showed that the 1^{st} P(S-co-C8S)-DPE block had Mₙ (GPC)=46,000 g/mol and M_{w}/Mₙ=1.03 with respect to PS calibration standards. The diblock copolymer molecular weight obtained from GPC is M_{n,P(S-co-C8S)-b-PS-b-P(MMA-co-C6MA)}=83,000 g/mol and M_{w}/Mₙ=1.07.

Table 1 compares Tg properties of the standard PS-b-PMMA (Example 1) to that of multi-tethered Synthesis Example 2 TAB-1

Other novel multi-tethered were synthesizes in a Similar Fashion and have their properties summarized in Table 2.

Synthesis examples TAB 1, TAB2, TAB 3, TAB 4 were made in the same manner as TAB but by varying MW to obtain different L₀ and so that these samples are suitable for use line and space (L/S) applications.

TAB 5 Example 6 Contact hole BCP was synthesized using the same procedure described in example TAB (Example 2) but by modifying the following variable in order to change the properties of PS mol % and MW in order to obtain a multi-tethered block copolymer which is suitable for use in for CH hole self-assembly.

### Underlayer Polymer Example 1

Synthesis of Random x-Linkable Copolymers:
Copolymer of Styrene, Methyl Methacrylate and 4-Vinylbenzycylobutene Synthesized with AIBN

A 2000-ml flask equipped with a condenser, temperature controller, heating mantle and mechanical stirrer were set up. 87.0 grams (0.84 moles) of styrene(S), 139.8 grams (1.40 moles) of methyl methacrylate (MMA), 72.4 grams (0.56 moles) of 4-Vinylbenzocyclobutene (VBCB) and 1.83 grams (0.011 moles) of Azobisisobutyronitrile (AIBN) initiator and 600 grams of anisole were added to the flask. The mechanical stirrer was turned on and set up at about 120 rpm. The reaction solution was then degassed by vigorously bubbling nitrogen through the solution for about 30 minutes at room temperature. After 30 minutes of degassing the heating mantle was turned on and the temperature controller was set at 70° C., and the stirred reaction mixture was maintained at this temperature for 20 hours. After this time the heating mantle was turned off and the reaction solution was allowed to cool down to about 40° C. Then the reaction mixture was poured into 12 L of isopropanol stirred with a mechanical stirring during the addition. During this addition, the polymer was precipitated out. The precipitated polymer was collected by filtration. The collected polymer was dried in vacuum oven at 40° C. About 170 grams of the polymer was obtained. This dried polymer was dissolved in 600 grams of THF and then filtered through a 0.2 um nylon filter. The filtered solution was then precipitated again into a stirred solution of 12 L methanol, the precipitated polymer collected and dried as before under vacuum at 40° C. In this manner, 150 grams (50% yields) of the polymer was obtained after dry. The polymer had an M_{w} of about 38k and a polydispersity (PDI) of 1.5.

### Self-Assembly of Block Copolymer (BCP) Based on Example 1 and 2 (Table 1)

The polymer of Underlayer Polymer Example 1 was dissolved in PGMEA to form 0.33 wt % solution. This solution was filtered using a 0.02 μm PTFE filter and then coated at 1500 rpm on SiOx wafers, and the wafers were subsequently each baked at 250° C. for 2 min in air to produce SiOx wafers coated with the crosslinked neutral layer (FT 8 nm). The wafers were then coated with a 0.02 m PTFE filtered 1.4 wt % solution in PGMEA of either the reference polymer Examples 1 (PS-b-PMMA) and TAB the polymer of multi-tethered diblock copolymer (Example 2) which were both spin coating at 1,500 rpm and subsequently individually soft baked at 110° C. for 1 min then annealed at 250° C. under N₂ for 1 hour. After this annealing bake films of either materials a self-assembled pattern in which an array of nanophase segregated lamellar perpendicular to the substrate were formed which contain the etchable block derived from methyl methacrylate which is a microphase segregated array suitable to use for etching pattern transfer into the substrate of a line and space array. However, the film coated with multi-tethered diblock copolymer (Example 2) was also showed a perpendicular lamellar morphology showed with significantly less numbers of network defects compared to regular diblock (Example 1) diblock copolymer of styrene and methyl methacrylate (PS-b-PMMA) (Mₙ=92K, PDI=1.02) (Example 1).

These novel diblock copolymers shows significant T_{g} reduction on both segment T_{g} and overall T_{g} (Table 2) Less network observed with higher grain sizes as shown in (FIG. 3) which shows a 1FOV SEM images, obtained with the following processing: the solution of Underlayer Neutral Copolymer 1 is coated and baked at: 250° C./1 hour (N₂); AZ® EBR 70/30 2 min, spin dry, 110° C./1 min, FT=45 nm.

Multi-tethered diblock shows improved grain sizes.

### Processing Example 2

The processing Example condition described in Processing Example 1 were mostly employed to prepare a film of Example 6 (TAB 5), which was multi-tethered block copolymer which was designed for contact hole (CH) self-assembly. The processing conditions were only changed slightly as follows: the block copolymer were baked at 260° C. for 15 minutes (N₂), then rinsed with AZ® EBR 70/30, spun dry for 2 min, followed by a bake for 110° C. for 1 min. In this instance a film thickness (FT) of 47 nm was obtained. FIG. 4 shows that this annealed film formed. Multi-tethered diblock shows improved contact hole assembly. In general, good C/H assembly are achieved with PS-b-PMMA block copolymer when low T_{g} additive were added. The current inventive multi-tethered diblock copolymers showed good C/H assembly without any additive indicates the significant kinetic enhancement. In contrast, as shown in FIG. 5 when a film of the regular diblock (Example 1), (a.k.a. diblock copolymer of styrene and methyl methacrylate (PS-b-PMMA) (Mₙ=66.92K, PDI=1.01) (Example 1a)), was prepared and processed in the same manner as the film of Example 6, described above, the resultant 34.2 nm contact holes, showed large areas of defects caused by mixed morphology.

One further advantage of the novel disclosed modified AB diblock copolymer (Example 2) is that one does not need to change the underlayers and pinning chemistry used currently in the DSA processing for unmodified PS-b-PMMA DSA.

TABLE 1
Td and T_{g} of regular PS-b-PMMA and modified
P(S-co-C8S)-b-P(MMA-co-C6MMA)

| | T_{d} | T_{g}1 | T_{g}2 |
|---|---|---|---|
| Sample | (5% wt loss) | ° C. | ° C. |
| AB (Example 1) | 336 | 107 | 118 |
| TAB (Example 2) | 343 | 81 | 99 |

TABLE 2
Diblock copolymer synthesis and characterization data

| | Mn PS | Mn, GPC | | | |
|---|---|---|---|---|---|
| | block | (BCP) | | | Lₒ |
| sample | (kg/mol) | (kg/mol) | PDI | V_{f}, PS_{(NMR)} | nm |
| EX 1 PS-b-PMMA | 47 | 92 | 1.02 | 0.49 | 45.78 |
| EX 2 TAB-1 | 46 | 83 | 1.07 | 0.50 | 39.15 |
| EX 3 TAB-2 | 57 | 99 | 1.06 | 0.51 | 42.82 |
| EX 4 TAB-3 | 62 | 105 | 1.03 | 0.48 | 43.00 |
| EX 5 TAB-4 | 68.5 | 114 | 1.03 | 0.49 | 46.9 |
| EX 6 TAB-5 | 56.4 | 88.3 | 1.02 | 0.69 | 37.8 |
| EX 7 TAB-6 | 63.4 | 98.7 | 1.02 | 0.71 | 40.8 |

1. A block copolymer having structure (I), wherein
A segment is a non-polar block copolymer segment comprising styrenic repeat units,
L is either a direct valence bond or a linking moiety derived from a 1,1-diarylethene;
B segment is a polar block copolymer segment comprising either alkyl 2-methylenealkanoate derived repeating units, lactone derived repeat units, oxirane derived repeat units, oxetane derived repeating units, or cyclic carbonate derived repeat units;
E′ is a C-1 to C-12 alkyl end group,
E″ is and end group selected from H an alkyl, a carbonylalkyl (—C═O-alkyl), a carbonyloxyalkyl (—C═O—O-alkyl, and an alkyl 2-arylacrylate derived end group (—CH₂—CH(Aryl)(C(═O))—O-alkyl); and further,
said block copolymer of structure (1) is multi-tethered with oligo flexible tethered groups which are selected from oligo linear alkylene tethered groups, oligo ether tethered groups, and oligo dialkyl siloxane tethered groups, and these oligo flexible tethered groups are multi-tethered on at least one of either the A segments, B segments, and L, if L is a linking moiety derived from a 1,1-diarylethene, and said block copolymer has a polydispersity ranging from 1 to about 1.09, and a Mn of at least 40,000:

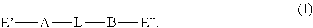

2. The block copolymer of claim 1, wherein said oligo flexible tethered groups are oligo linear alkylene tethered groups.

3. The block copolymer of claim 1, wherein said oligo flexible tethered groups are oligo linear alkylene tethered group having the general structure —X1—(CH₂)ₐ—CH₃, wherein n is 6 to 19 and X1 is and X1 is selected from a direct valence bond, a linear C-1 to C-4 alkylene spacer, —O—, —CH₂—O—, —O—(C═O)—, —C═O—O—, C═O, —CH₂—O—(C═O)—, —S—, —SO₂—, and —SO—.

4. The block copolymer of claim 1, wherein said oligo flexible tethered groups are oligo ether tethered groups.

5. The block copolymer of claim 1, wherein said oligo flexible tethered groups are oligo ether tethered groups, which have the formulas: —O—[(CH₂)ₑ—O—]ₑ₂—(CH₂)ₑ₃—H, or —(CH₂)ₑ₄—O—[(CH₂)ₑ—O—]ₑ₂—(CH₂)ₑ₃—H, wherein independently e is from 2 to 8, e2 is from 2 to 8, e3 is from 1 to 8, and e4 is from 1 to 8.

6. The block copolymer of claim 1, wherein said oligo flexible tethered groups are oligo dialkyl siloxane tethered groups.

7. The composition of claim 1, wherein said oligo flexible tethered groups are oligo dialkyl siloxane tethered groups which have the formula —X2-[Si(alkyl)₂-O]ₛ—Si(alkyl)₃, where s is from 6 to 18 and the alkyl moiety is a C-1 to C-8 alkyl and X2 is a direct valence bond, or a C-1 to C-8 linear alkylene spacer, or —O—.

8. The block copolymer of claim 1, wherein said polar block copolymer segment B comprises repeat units derived from a lactone.

9. The block copolymer of claim 1, wherein said polar block copolymer segment B comprises repeat units derived from an alkyl 2-methylenealkanoate.

10. The block copolymer of claim 1, wherein said polar block copolymer segment B segment has a Mw between about 20,000 and about 200,000 and said non-polar styrenic block copolymer segment A has a Mw between 20,000 and about 200,000.

11. The block copolymer of claim 1, wherein L is a direct valence bond.

12. The block copolymer of claim 1, wherein L is a linking group derived from a 1,1-diarylethene.

13. The block copolymer of claim 1, wherein E″ is H.

14.-17. (canceled)

18. The block copolymer of claim 1, wherein oligo flexible tethered groups are located on the A segments and are either randomly located along this segment on some of its repeat units or present on each of its repeat units.

19. The block copolymer of claim 1, wherein said oligo flexible tethered groups are located on the B segment and are either randomly located along this segment on some of its repeat units or present on each of its repeat units.

20. The block copolymer of claim 1, wherein said oligo flexible tethered groups are located on the linking group L, when it is derived from a 1,1-diarylethene.

21. The block copolymer of claim 1, wherein said oligo flexible tethered groups are located on the A segment, the B segment, and the linking group L, if L is derived from a 1,1-diarylethene and are either randomly located along A segment or B Segment on some of their respective repeat units or present on each of their respective repeat units.

22.-29. (canceled)

30. The block copolymer of claim 1, wherein said copolymer has structure (II), comprising
a styrenic block consisting of the randomly copolymerized styrenic repeat units of structures (STa) and (STb) wherein R₁ and R₂ are individually selected from H or a C-1 to C-4 alkyl, R₅ and R₆ are individually selected from H or a C-1 to C-4 alkyl, and an oligo flexible tethered group which are selected from an oligo linear alkylene tethered group, an oligo ether tethered groups, and an oligo dialkyl siloxane tethered groups;
a linking moiety of structure (L₁), wherein R₇ and R₃ are individually selected from H, a C-1 to C-4 alkyl and a is multi-tethered with oligo flexible tethered group which is selected from an oligo linear alkylene tethered group, an oligo ether tethered groups, and an oligo dialkyl siloxane tethered groups;
a 2-methylenealkanoate derived block consisting of the randomly copolymerized 2-methylenealkanoate-repeat units of structures (MEAa) and (MEAb), wherein R₃ and R₄ and individually selected from a C-1 to C-4 alkyl and R₉ and R₁₀ are individually selected from a C-1 to C-4 alkyl and is multi-tethered with oligo flexible tethered group which is selected from an oligo linear alkylene tethered group, an oligo ether tethered groups, and an oligo dialkyl siloxane tethered groups;
E′ is a C-1 to C-10 alkyl end group,
E″ is selected from H an alkyl, a carbonylalkyl (—C═O-alkyl), a carbonyloxyalkyl (—C═O—O-alkyl, and an alkyl 2-arylacrylate derived end group (—CH₂—CH(Aryl)(C(═O))—O-alkyl);
x and x′ designate respectively the number of repeat units of structures (STa) and (STb) in said styrenic block having a Mw from about 20,000 to about 200,000, and in this non-polar block segment it is delineated by the parenthesis designated by n,
y and y′ designate respectively the number of repeat units of structures (MEAa) and (MEAb) in said 2-methylenealkanoate derived block having a Mw from about 20,000 to about 200,000, and in this polar block segment it is delineated by the parenthesis designated by m, and further wherein at least one of structures (STa), (STb), (L₁), (MEAa) and (MEAb) respectively have R₅, R₆, R₇, R₈, R₉ or R₁₀ is selected from said oligo flexible tethered group

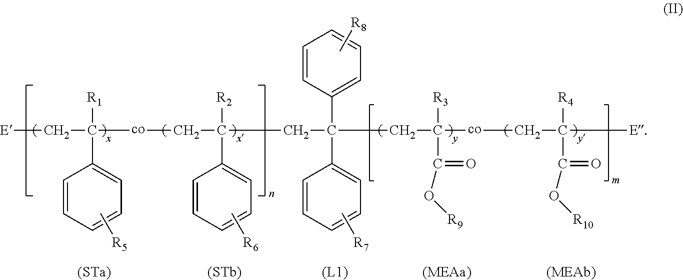

31. The block copolymer of claim 30, wherein R₅ is an oligo flexible tethered group, R₆ is H or a C-1 to C-4 alkyl, R₇ and R₈ are individually selected from H and a C-1 to C-4 alkyl, R₉ and R₁₀ are individually selected from a C-1 to C-4 alkyl.

32. The block copolymer of claim 30, wherein R₅ and R₆ are multi-tethered with oligo flexible tethered groups, R₇ and R₈ are individually selected from H and a C-1 to C-4 alkyl, R₉ and R₁₀ are individually selected from a C-1 to C-4 alkyl.

33. The block copolymer of claim 30, wherein R₅ and R₆ are individually selected from H and a C-1 to C-4 alkyl, at least one of R₈ and R₇ is an oligo flexible tethered group and R₉ and R₁₀ are individually selected from a C-1 to C-4 alkyl.

34. (canceled)

35. The block copolymer of claim 30, wherein R₅ and R₆ are individually selected from H and a C-1 to C-4 alkyl, R₈ and R₇ are individually selected from H and a C-1 to C-4 alkyl, and at least one of R₉ and R₁₀ is an oligo flexible tethered group.

36. The block copolymer of claim 30, wherein both R₉ and R₁₀ are oligo flexible tethered group

37.-44. (canceled)

45. A block copolymer having structure (III), wherein
A₁ is a styrenic block copolymer segment, which has a T_{g} from about 50° C. to about 100° C.
A₂ is block copolymer segment with a T_{g} ranging from about −5° C. to about −50° C., which comprises repeat units derived from either an olefin selected from the group consisting of an alkene, an alkadiene, and an alkatriene, or a from mixture of at least two different olefins selected from this group;
B₁ is a polar block copolymer segment, which has a T_{g} of about 50° C. to about 100° C., comprising either alkyl 2-methylenealkanoate derived repeating units, lactone derived repeat units, oxirane derived repeat units, oxetane derived repeating units, or cyclic carbonate derived repeat units;
L₁ is either a direct valence bond or a linking moiety derived from a 1,1-diarylethene; wherein
E³ is an alkyl,
E⁴ is an groups selected from H, an alkyl, a carbonylalkyl (—C═O-alkyl), a carbonyloxyalkyl (—C═O—O-alkyl, and an alkyl 2-arylacrylate derived end group (—CH₂—CH(Aryl)(C(═O))—O-alkyl), and further wherein
said block copolymer has a polydispersity ranging from 1 to about 1.09,

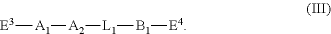

46.-48. (canceled)

49. The block copolymer of claim 1, wherein said A₂ comprises a mixture of at least two different repeat units having structures (IIIa), (IIIb), (IIIc), and (IIId), derived from an alkadiene; wherein R_{d}, R_{d1}, R_{d3}, R_{d4}, Rₑ, Rₑ₁, Rₑ₃, and Rₑ₄ are individually selected from the group consisting of a H, and a C-1 to C-8 alkyl, and further wherein the total mole % of olefinic repeat units in said block copolymer ranges from about 3 mole % to about 50 mole %;

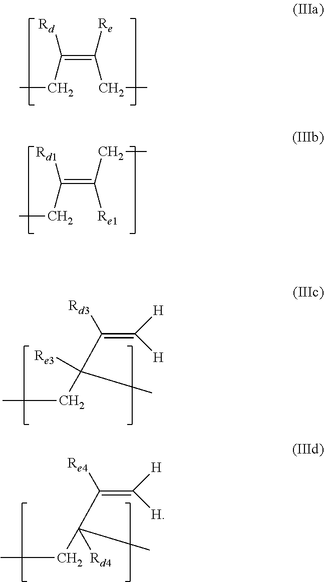

50.-63. (canceled)

64. The block copolymer of claim 45, having structure (IIIe), comprising:
a styrenic block consisting of the randomly copolymerized styrenic repeat units of structures (STc) and (STc) wherein R₁ₐ and R₂ₐ are individually selected from H or a C-1 to C-4 alkyl, R₅ₐ and R₆ₐ are individually selected from H or a C-1 to C-4 alkyl,
a linking moiety of structure (L₁), wherein R₇ₐ and R₈ₐ are individually selected from H, and a C-1 to C-4 alkyl, wherein
E′ is a C-1 to C-20 alkyl end group,
E″ is selected from H an alkyl, a carbonylalkyl (—C═O-alkyl), a carbonyloxyalkyl (—C═O—O-alkyl, and an alkyl 2-arylacrylate derived end group (—CH₂—CH(Aryl)(C(═O))—O-alkyl);
x and x′ designate respectively the number of repeat units of structures (STc) and (STd) in said styrenic block having a Mw from about 20,000 to about 200,000, in this non-polar block segment it is delineated by the parenthesis designated by n,
y and y′ designate respectively the number of repeat units of structures (MEAc) and (MEAd) in said a 2-methylenealkanoate derived block having a Mw from about 20,000 to about 200,000, in this polar block segment delineated by the parathesis designated by m, wherein R₃ₐ and R₄ₐ, R₉ₐ and R₁₀ₐ are individually selected from a C-1 to C-4 alkyl,
A₂ is block copolymer segment with a T_{g} ranging from about −5° C. to about −50° C., which comprises repeat units derived from either an olefin selected from the group consisting of an alkene, an alkadiene, and an alkatriene, or from mixture of at two different olefins selected from this group;

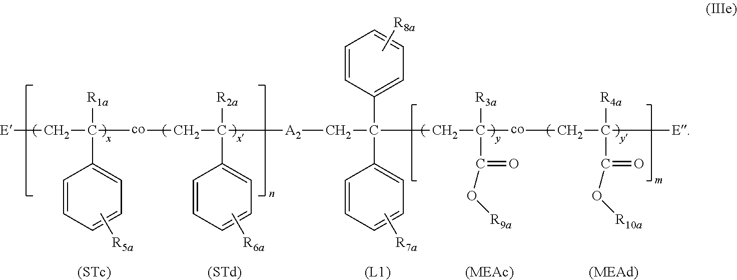

65.-67. (canceled)

68. The block copolymer of claim 1, wherein said A₂ comprises a mixture of at least two different repeat units having structures (IIIa), (IIIb), (IIIc), and (IIId); wherein R_{d}, R_{d1}, R_{d3}, R_{d4}, Rₑ, Rₑ₁, Rₑ₃, and Rₑ₄, are individually selected from the group consisting of a H, and a C-1 to C-8 alkyl, and further wherein the total mole % of olefinic repeat units in said block copolymer ranges from about 3 mole % to about 50 mole %;

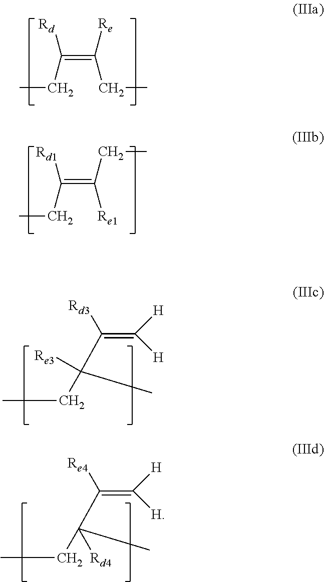

69.-73. (canceled)

74. A composition comprising a least one block copolymer of claim 1 and a spin casting organic solvent.

75.-76. (canceled)

77. A method of vertically orienting first and second block copolymer domains over an unpatterned substrate using a layer of a block copolymer having a periodicity of L₀ comprising the steps of:
a) forming a coating layer of a block copolymer from the composition of claim 74 on said unpatterned substrate; and
b) annealing the layer of the block copolymer to generate a non-zero positive integer number of first and second block copolymer domains, vertically oriented on said unpatterned substrate.

78. A method of vertically orienting first and second block copolymer domains over a first patterned substrate where the height of topography of the pattern on the substrate is at least 0.7 times L₀ and aligning the domains with the pattern, using a coating comprising a block copolymer having a periodicity of L₀ comprising the steps of:
a1) forming a coating layer of the composition of claim 74 on said first topographical substrate, wherein the thickness of the average thickness of the coating layer of the block copolymer is less than the height of the topography of the first topographical substrate, wherein the block copolymer layer is laterally confined by the topography; and
b1) annealing the block copolymer layer to generate first and second block copolymer domains, vertically oriented on said first patterned substrate, and confined within the recessed region.

79. A method of vertically orienting, first and second block copolymer domains with a periodicity of L₀ over a second patterned substrate having a topographical pattern with the height of topography larger than 0.7 times L₀ and a pitch P1 where the pitch P1 is a non-zero positive integer multiplied by Lo, and aligning the domains with the pattern comprising the steps of:
a2) forming a coating layer of a block copolymer with the composition of claim 74 on said second patterned substrate, where the thickness of the coating layer of the block copolymer is more than the height of the topography of the second patterned substrate; and
b2) annealing the block copolymer layer to generate a non-zero positive integer number of first and second block copolymer domains vertically oriented on said second patterned substrate and aligning them to the second patterned substrate where the sum of vertically oriented domains is equal or larger than the pitch P1 the of topographical pattern.

80. A method of vertically orienting first and second block copolymer domains over a substrate having a surface chemical prepattern having a pitch P2, where the pitch P2 is a non-zero positive integer multiplied by L₀ and aligning the domains comprising the steps of:
a3) forming a coating layer of a block copolymer with the composition of claim 74 on the substrate having a surface chemical prepattern; and
b3) annealing the block copolymer layer to generate vertically oriented first and second block copolymer domains aligned with the substrate having a surface chemical prepattern having a pitch P2.

81. A composition comprising the block copolymer of claim 45 and a solvent.

82.-83. (canceled)

84. A method of vertically orienting first and second block copolymer domains over an unpatterned substrate using a layer of a block copolymer having a periodicity of L₀ comprising the steps of:
a4) forming a coating layer of a block copolymer from the composition of claim 81
on said unpatterned substrate; and
b4) annealing the layer of the block copolymer to generate a non-zero positive integer number of first and second block copolymer domains, vertically oriented on said unpatterned substrate.

85. A method of vertically orienting first and second block copolymer domains over a first patterned substrate where the height of topography of the pattern on the substrate is at least 0.7 times L₀ and aligning the domains with the pattern, using a coating comprising a block copolymer having a periodicity of L₀ comprising the steps of:
a5) forming a coating layer of the composition of claim 81 on said first topographical substrate, wherein the average thickness of the coating layer of the block copolymer is less than the height of the topography of the first topographical substrate, wherein the block copolymer layer is laterally confined by the topography; and
b5) annealing the block copolymer layer to generate first and second block copolymer domains, vertically oriented on said first patterned substrate, and confined within the recessed region.

86. A method of vertically orienting, first and second block copolymer domains with a periodicity of L₀ over a second patterned substrate having a topographical pattern with the height of topography larger than 0.7 times L₀ and a pitch P1 where the pitch P1 is a non-zero positive integer multiplied by L₀, and aligning the domains with the pattern comprising the steps of:
a6) forming a coating layer of a block copolymer with the composition of claim 81 on said second patterned substrate, where the thickness of the coating layer of the block copolymer is more than the height of the topography of the second patterned substrate; and
b6) annealing the block copolymer layer to generate a non-zero positive integer number of first and second block copolymer domains vertically oriented on said second patterned substrate and aligning them to the second patterned substrate where the sum of vertically oriented domains is equal or larger than the pitch P1 the of topographical pattern.

87. A method of vertically orienting first and second block copolymer domains over a substrate having a surface chemical prepattern having a pitch P2, where the pitch P2 is a non-zero positive integer multiplied by L₀ and aligning the domains comprising the steps of:
a7) forming a coating layer of a block copolymer with the composition of claim 81 on the substrate having a surface chemical prepattern; and
b7) annealing the block copolymer layer to generate vertically oriented first and second block copolymer domains aligned with the substrate having a surface chemical prepattern having a pitch P2.

88. (canceled)
